(19) United States
(12) Patent Application Publication
(10) Pub. No.: US 2025/0156690 A1
(43) Pub. Date: May 15, 2025

(54) INLINE AND IN-MEMORY TWO-DIMENSIONAL CONVOLUTION AND CONVOLUTIONAL NEURAL NETWORK HARDWARE ENGINES FOR NETWORKING DEVICES

(71) Applicant: HUAWEI TECHNOLOGIES CO., LTD., Shenzhen (CN)

(72) Inventor: Francisco FONS LLUIS, Munich (DE)

(73) Assignee: HUAWEI TECHNOLOGIES CO., LTD., Shenzhen (CN)

(21) Appl. No.: 19/025,671

(22) Filed: Jan. 16, 2025

Related U.S. Application Data
(63) Continuation of application No. PCT/EP2022/070052, filed on Jul. 18, 2022.

(51) Int. Cl. G06N 3/0464

(52) U.S. Cl. CPC G06N 3/0464

(57) ABSTRACT

A two-dimensional (2D) convolution hardware engine for a networking device includes processing circuitry that further includes multiple processing stages forming a pipeline to perform an inline and in-memory 2D convolution operation on a received dataset. A first processing stage of the pipeline shifts the dataset in a first direction of a 2D space, a second processing stage shifts the dataset in a second direction of the 2D space, a third processing stage calculates a product of each pixel of a kernel of the shifted 2D image by multiplying the pixel with a filter weight of the kernel, and a fourth processing stage calculates a sum of the products of all pixels of the kernel of the shifted 2D image. A convolutional neural network (CNN) computation hardware engine for performing an inline and in-memory CNN computation operation on the received dataset is included.

### CROSS-REFERENCE TO RELATED APPLICATIONS

This application is a continuation of International Application No. PCT/EP2022/070052, filed on Jul. 18, 2022, the disclosure of which is hereby incorporated by reference in its entirety.

### FIELD

The present disclosure relates to two-dimensional (2D) convolution in a networking device. The present disclosure provides a 2D convolution hardware engine and a corresponding method for performing an inline and in-memory 2D convolution operation on a received dataset. The present disclosure also provides a convolutional neural network (CNN) computation hardware engine and a corresponding method for performing an inline and in-memory CNN computation operation on the received dataset.

### BACKGROUND

Today the execution of 2D convolution and CNN computation primitives consists, in general, in executing lines of software code on general-purpose core processing unit (CPU) or graphics processing unit (GPU) hardware devices, on specific hardware System-on-Chip (SoC) devices like Google Tensor Processing Units (TPUs), or on Tesla Full Self-Driving (FSD) SoCs. However, all of these solutions are oriented to perform the time-intensive convolution through the execution of lines of software code on a given Arithmetic-Logic Unit (ALU) on a static computing platform. This can be done, for instance, for a datacenter or for cloud computation.

None of the above described conventional solutions are oriented to perform the processing inline inside a networking device. In addition, prior software-based solutions, sometimes supported by dedicated hardware but still managed through the execution of code, may be inefficient or still leave room for improvement in terms of performance and/or power consumption.

### SUMMARY

The present disclosure provides a more efficient solution for performing a 2D convolutional operation. To promote processing inline inside a networking device a 2D convolution hardware engine which is embeddable into a networking device is described. The present disclosure describes integrating the hardware engine into a data path of a networking device in order to enable an inline 2D convolution operation or an inline CNN computation. The present disclosure also describes performing the inline 2D convolution operation in-memory, i.e., without the need of a dedicated stage of buffering data through the use of external memory devices, which are before the inline 2D convolution operation. The present disclosure also provides a compact solution able to perform computation at line-rate.

A first aspect of the present disclosure provides a 2D convolution hardware engine for a networking device, the 2D convolution hardware engine includes processing circuitry, where the processing circuitry includes multiple processing stages connected to form a pipeline and configured to perform an inline and in-memory 2D convolution operation on a received dataset, the multiple processing stages including: a first processing stage of the pipeline that is configured to shift the dataset in a first direction of a 2D space, a second processing stage of the pipeline that is configured to shift the dataset in a second direction of the 2D space, a third processing stage of the pipeline that is configured to calculate a product of each pixel of a kernel of the shifted dataset by multiplying the pixel with a filter weight of the kernel, and a fourth processing stage of the pipeline that is configured to calculate a sum of the products of all pixels of the kernel of the shifted dataset.

The 2D convolution hardware engine may be a dedicated hardware intellectual property (IP)-Core. The 2D convolution hardware engine may not require a CPU to execute lines of software code in order to execute parts of or all of a 2D convolution algorithm. A CPU may only be used in an initialization phase, also referred to as startup phase, for example to configure configurable registers. Such configurable registers will be described later.

The 2D convolution hardware engine of the first aspect is at least partly implemented in hardware, or is provided as an at least partly hardware-based solution. However, it may be fully implemented in hardware or it may be a fully hardware-based solution. The performance of the 2D convolution hardware engine may be higher than that of a software-based solution. Performance related advantages, in comparison to software-based solutions, may, for example, include a latency reduction. The 2D convolution hardware engine may be a customized solution oriented to Application Specific Integrated Circuit (ASIC) design, and may thus deliver better power consumption, especially a lower power consumption, than conventional CPU or GPU based solutions.

The multiple processing stages of the pipeline are performed consecutively and in parallel. The multiple processing stages may also be partly performed consecutively and partly in parallel. Each processing stage may be an individual piece of hardware of the processing circuitry.

The 2D convolution operation may be a computation operation that is performed inline, for example, as soon as the dataset is received across ingress ports of the networking device. The received dataset of the 2D convolution hardware engine may be, for example, an ingress frame received across the ingress ports of the networking device.

The 2D convolution operation may be a computation operation that is performed in-memory, i.e., that makes use of internal memory belonging to the hardware engine itself, without requiring external memory to partially or entirely buffer data of the required dataset.

A large buffer to store a full dataset, such as a full image, is not necessary as the 2D convolution operation is processed inline as soon as some input data is available.

In the first processing stage, the dataset, for example a 2D image, is shifted in the first direction, for example a Y direction, of the 2D space. In the example of the 2D image, in the first processing stage, full columns of one or more pixels width of the 2D image may be shifted from right to left, thus, splitting the 2D image in slices.

In the second processing stage, the dataset, for example the 2D image, is shifted in the second direction, for example an X direction of the 2D space. In the example of the 2D image, in the second processing stage one or more kernels of K×K pixels may be shifted from a bottom to a top of the 2D image.

In the third processing stage, the product of each pixel of the kernel of the shifted 2D image is calculated by multiplying the pixel, for example of the 2D image, with the filter weight of the kernel. A filter may be for example a 5×5 Sobel filter for image processing.

In the fourth processing stage, the sum of the products of all pixels of the kernel of the shifted dataset, for example the 2D image, is calculated.

Due to the fact that the received dataset may be processed inline and in-memory, for instance, as soon as it is received, by the 2D convolution hardware engine, a compact solution with little buffering of data inside the 2D convolution hardware engine through internal memory blocks is achieved, and buffering can generally be minimized.

In an implementation form of the first aspect, the dataset is a 2D image.

In the present disclosure the dataset is not intended to be restricted to a specific type of dataset. The dataset may, for example, be a frame or may also be referred to as a data frame. The dataset may for example be an ingress frame or a collection of frames received through streaming from a camera, for instance, through Mobile Industry Processor Interface (MIPI) frames comprising a full image or a sequence of images, e.g. video frames. A frame may include a packet and or a segment. Packets may also be referred to as network packets. The dataset may also be a combination of different types of datasets. For example, specific information codified according to some protocol and accommodated in order to encapsulate the data in a specific format and distributed in a specific manner to be processed inline by the 2D convolution hardware engine.

The 2D convolution hardware engine of the present disclosure is therefore a very flexible solution which is applicable to many types of data in a wide variety of technologies or industries.

In an implementation form of the first aspect the inline and in-memory 2D convolution is executed in parallel and/or simultaneously for two or more pixels of the dataset.

For example the inline 2D convolution operation including the multiple processing stages may be performed in parallel and/or simultaneously for two or more pixels of a 2D image. This may be implemented by scaling the multiple processing stages accordingly in order to allocate more than one kernel concurrently. For instance, by instantiating multiple columns and rows of pixels in the X and Y shift stages of the 2D convolution hardware (HW) engine, it is possible to perform the 2D convolution of multiple pixels at the same time by reusing the overlapped kernels of the pixels affected. This optimizes the implementation in terms of shared HW resources and execution time by exploiting the parallelism offered by the hardware, e.g., increasing the throughput to two or more pixels per clock instead of one pixel per clock, according to the selected HW configuration and the area-time duality.

Overlapped resources along the multiple processing stages may thus be shared. This may result in an improved performance.

In an implementation form of the first aspect the 2D convolution hardware engine further includes a first set of configurable registers configured to be programmed with a first set of values, and to be accessible by the processing circuitry at an initialization phase and/or during the inline 2D convolution operation of the 2D convolution hardware engine. The first set of values defines one or more physical parameters related to the inline 2D convolution operation performed on the dataset.

The 2D convolution hardware engine may be designed in a flexible way through a parameterization of main structural and behavioral characteristics of the 2D convolution hardware engine. The first set of values may define one or more physical parameters for example kernel size and values Kj, i, data depth, e.g., bits and/or number of pixels operated in parallel. The one or more configurable physical parameters may be abstracted into the first set of configurable registers. The one or more configurable physical parameters may therefore be memory mapped. The 2D convolution hardware engine may be accessible by a CPU which may be instantiated in a SoC.

Thus, the 2D convolution hardware engine is a solution that may be applied flexibly to different application scenarios. For example, the 2D convolution hardware engine may be used as a standalone peripheral of a SoC. The 2D convolution hardware engine may, for example, also be integrated into a CNN computation hardware engine, where the CNN computation hardware engine may be integrated into the SoC.

This modular design is beneficial for scaling the solutions of the present disclosure.

Programming the first set of values into the first set of configurable registers may include a user that programs the first set of values into the first set of configurable registers. The user may for example be a physical person that manually programs the first set of values into the first set of configurable registers. The user may also be any kind of processing circuitry, for example, a CPU or processing unit configured to automatically program the first set of values into the first set of configurable registers.

The initialization phase may be a phase in which the 2D convolution hardware engine and/or the CNN computation hardware engine may be initialized and may also be referred to as a startup phase.

In an implementation form of the first aspect the first set of configurable registers are configured to be memory mapped.

The memory mapped first set of configurable registers may be accessible by a host CPU at an initialization phase of the 2D convolution hardware engine.

In an implementation form of the first aspect the 2D convolution hardware engine further includes a second set of configurable registers configured to be programmed with a second set of values, and to be accessible by the processing circuitry at the initialization phase and/or during the inline 2D convolution operation of the 2D convolution hardware engine. The second set of values defines one or more functional parameters related to the inline 2D convolution operation performed on the dataset.

The 2D convolution hardware engine may be designed in a flexible way through a parameterization of main structural and behavioral characteristics of the 2D convolution hardware engine. The second set of values may define one or more functional parameters, for example, filter parameters of the 2D convolution hardware engine, type of CNN, number of CNN layers, pooling strategy, activation function, padding and/or stride applied to CNN. The one or more configurable functional parameters may be abstracted into the second set of configurable registers. The one or more configurable functional parameters may therefore be memory mapped. The 2D convolution hardware engine may be accessible by a CPU which may be instantiated in a SoC.

Thus, the 2D convolution hardware engine is a solution that may be applied flexibly to different application scenarios. For example the 2D convolution hardware engine may be used as a standalone peripheral of a SoC. The 2D convolution hardware engine may for example also be integrated into a CNN computation hardware engine, where the CNN computation hardware engine may be integrated into the SoC.

This modular design is beneficial for scaling the solutions of the present disclosure.

Programming the second set of values into the second set of configurable registers may include a user that programs the second set of values into the second set of configurable registers. The user may for example be a physical person that manually programs the second set of values into the second set of configurable registers. The user may also be any kind of processing circuitry, for example a CPU or processing unit configured to automatically program the second set of values into the second set of configurable registers.

The initialization phase may be a phase in which the 2D convolution hardware engine and/or the CNN computation hardware engine may be initialized and may also be referred to as a startup phase.

In an implementation form of the first aspect the second set of configurable registers are configured to be memory mapped.

The memory mapped second set of configurable registers may be accessible by a host CPU at an initialization phase of the 2D convolution hardware engine and/or the CNN computation hardware engine.

In an implementation form of the first aspect the 2D convolution hardware engine further includes an ingress port for receiving the dataset, and/or an egress port for outputting a result of the 2D convolution operation performed on the dataset.

A second aspect of the present disclosure provides a convolutional neural network (CNN) computation hardware engine configured to perform an inline and in-memory CNN computation operation on a received dataset including an ingress port for receiving the dataset, a 2D convolution hardware engine according to the first aspect configured to perform the inline 2D convolution operation on the dataset, an egress port for outputting a result of the inline 2D convolution operation performed on the dataset, and a loopback path configured to loop back a result output by the 2D convolution hardware engine as an input to the 2D convolution hardware engine to form a CNN path.

A CNN computation operation may, amongst others, include a pooling CNN computation operation and/or an activation function CNN computation operation.

The loopback path may enable an effective implementation of algorithms that either are recursive or require to iterate on the same type of computation several times before ending, as is the case with CNN computation operations. The present disclosure provides, through the loopback path, a cost-effective solution based on hardware reuse.

In an implementation form of the second aspect the CNN computation hardware engine further includes one or more multiplexers (MUX) configured to select between two or more input datasets to output one selected output dataset.

A MUX may, for example, be an electronic selection circuit that allows one of a plurality of input signals of the MUX to be selected and to be passed through to an output of the MUX.

In an implementation form of the second aspect the CNN computation hardware engine further includes one or more dual-port random access memories (RAMs) configured to simultaneously permit one or more reads and one or more writes of one or more datasets.

In an implementation form of the second aspect the one or more dual-port RAMs are either one or more first in first out (FIFO) or simple and/or true dual-port RAM memories configured to queue one or more input datasets and/or one or more output datasets of the 2D convolution hardware engine.

The FIFO or simple and/or true dual-port RAM memories may also be referred to as queues. The dual-port RAMs may also be referred to as DPRAMs.

In an implementation form of the second aspect the CNN computation hardware engine further includes a pooling processing stage configured to reduce the dimension of the dataset.

The pooling CNN computation operation may be an operation performed by the CNN computation hardware engine at the pooling processing stage, where the pooling CNN computation operation may reduce the dimension of the dataset.

In an implementation form of the second aspect the CNN computation hardware engine further includes an activation function processing stage configured to calculate a weighted sum of the pixels of the kernel input to the activation function processing stage, and add a bias to the weighted sum.

The activation function CNN computation operation may be an operation performed by the CNN computation hardware engine at the activation function processing stage, where the activation function CNN computation operation may reduce the dimension of the dataset.

In an implementation form of the second aspect the CNN computation hardware engine further includes two or more dual-port RAMs including at least a first dual-port RAM and a second dual-port RAM, where the loopback path is further configured to loop back the output of the 2D convolution hardware engine and/or the pooling processing stage and/or the activation function processing stage to the first dual-port RAM and/or to the second dual-port RAM to form a residual CNN path, a shift processing stage including a first shift processing stage configured to shift a dataset in a first direction of a 2D space, and a second shift processing stage configured to shift the dataset in a second direction of the 2D space, and an adding processing stage configured to add a result output by the 2D convolution hardware engine to an output of the second dual-port RAM.

The residual CNN path may amongst others, for example be applicable for the implementation of, AlexNet CNNs, GoogLeNet CNNs and/or ResNet CNNs.

An extremely flexible CNN hardware architecture based on modular and configurable building blocks architecture is provided by the present disclosure by means of the CNN computation hardware engine. For example, plain CNNs as well as residual CNNs, for example AlexNet, GoogLeNet and/or ResNet, may be implementable fully in hardware by means of the CNN computation hardware engine. Furthermore, a freely selectable number of CNN layers, for example ResNet-34/50/152, may be implementable fully in hardware by means of the CNN computation hardware engine.

In an implementation form of the second aspect the CNN computation hardware engine further includes a third set of configurable registers configured to be programmed with a third set of values, and to be accessible by the processing circuitry at an initialization time and/or during the inline CNN computation operation of the CNN computation hardware engine. The third set of values defines one or more physical parameters related to the inline CNN computation operation performed on the dataset.

The 2D convolution hardware engine may be designed in a flexible way through a parameterization of main structural and behavioral characteristics of the CNN computation hardware engine. The third set of values may define one or more physical parameters for example kernel size, data depth, for example, bits and/or number of pixels operated in parallel, structure of the CNN based on number of layers, size and type of convolutions, pooling and activation function stages. The one or more configurable physical parameters may be abstracted into the third set of configurable registers. The one or more configurable physical parameters may therefore be memory mapped. The CNN computation hardware engine may be accessible by a CPU which may be instantiated in a SoC.

Thus, the CNN computation hardware engine is a solution that may be applied flexibly to different application scenarios. The 2D convolution hardware engine may for example be integrated into the CNN computation hardware engine, where the CNN computation hardware engine may be integrated into a SoC.

This modular design is beneficial for scaling the solutions of the present disclosure.

Programming the third set of values into the third set of configurable registers may include a user that programs the third set of values into the third set of configurable registers. The user may for example be a physical person that manually programs the third set of values into the third set of configurable registers. The user may also be any kind of processing circuitry, for example a CPU or processing unit configured to automatically program the third set of values into the third set of configurable registers.

The initialization phase may be a phase in which the 2D convolution hardware engine and/or the CNN computation hardware engine may be initialized and may also be referred to as a startup phase.

In an implementation form of the second aspect the third set of configurable registers are configured to be memory mapped.

The memory mapped third set of configurable registers may be accessible by a host CPU at an initialization phase of the 2D convolution hardware engine.

In an implementation form of the second aspect the CNN computation hardware engine further includes a fourth set of configurable registers configured to be programmed with a fourth set of values, and to be accessible by the processing circuitry at the initialization time and/or during the inline CNN computation operation of the CNN computation hardware engine. The fourth set of values defines one or more functional parameters related to the inline CNN computation operation performed on the dataset.

The 2D convolution hardware engine may be designed in a flexible way through a parameterization of main structural and behavioral characteristics of the CNN computation hardware engine. The fourth set of values may define one or more functional parameters for example filter parameters of the 2D convolution hardware engine, type of CNN, number of CNN layers, pooling strategy, activation function, padding and/or stride applied to CNN. The one or more configurable functional parameters may be abstracted into the fourth set of configurable registers. The one or more configurable functional parameters may therefore be memory mapped. The CNN computation hardware engine may be accessible by a CPU which may be instantiated in a SoC.

Thus, the CNN computation hardware engine is a solution that may be applied flexibly to different application scenarios. The 2D convolution hardware engine may for example be integrated into the CNN computation hardware engine, where the CNN computation hardware engine may be integrated into a SoC.

This modular design is advantageous for scaling the solutions of the present disclosure.

Programming the fourth set of values into the fourth set of configurable registers may include a user that programs the fourth set of values into the fourth set of configurable registers. The user may for example be a physical person that manually programs the fourth set of values into the fourth set of configurable registers. The user may also be any kind of processing circuitry, for example a CPU or processing unit configured to automatically program the fourth set of values into the fourth set of configurable registers.

The initialization phase may be a phase in which the 2D convolution hardware engine and/or the CNN computation hardware engine may be initialized and may also be referred to as a startup phase.

In an implementation form of the second aspect the fourth set of configurable registers are configured to be memory mapped.

The memory mapped forth set of configurable registers may be accessible by a host CPU at an initialization phase of the 2D convolution hardware engine.

A third aspect of the present disclosure provides a networking device configured to receive a dataset as an input and provide a processed dataset as an output, the networking device including: a normalization processing stage, where the networking device is configured to perform normalization functions on the received dataset in the normalization processing stage, a match processing stage, where the networking device is configured to perform filtering and policing functions on the normalized dataset in the match processing stage, and an action processing stage configured to perform switching, routing and gatewaying processing functions on the filtered and policed dataset in the action processing stage, or any other inline processing like 2D convolution and/or CNN computation. The action processing stage comprises a 2D convolution hardware engine and the 2D convolution hardware engine is configured to perform inline 2D convolution operations on the filtered and policed dataset in the action processing stage.

The networking device may, for example, be a switch, a SmartNIC, a router, or a Gateway.

The 2D convolution hardware engine and/or the CNN computation hardware engine proposed by the present disclosure may be implemented and ported to a commercial networking device or a commercial networking SoC device. Although the present disclosure is explained in the context of an automotive networking device, the present disclosure may also be implemented into non-automotive networking devices.

The 2D convolution hardware engine and/or the CNN computation hardware engine proposed by the present disclosure may in general improve architecture, performance and QoS of networking devices focusing on 2D convolution. This advantage is also supported by the flexibility of prioritization of each individual frame.

The normalization functions performed on the received dataset may, for example, be the adaptation of Ethernet Layer 2 frames or MIPI frames. For instance, in order for these frames to be effectively processed by the 2D convolution hardware engine, for example, in case of image processing of streaming data coming from a camera and/or the CNN computation hardware engine for a specific network intrusion detection system (NIDS) based on deep learning (DL). Or, for instance, to be able to detect attacks in real time and respond to these attacks by modifying and/or adding new rules in the firewall to drop frames injected in the network traffic by an attacker.

The filtering and policing functions performed on the normalized dataset may for example be a firewall structure like IPTABLES, or an intrusion detection system like SNORT or SURICATA implementing a set of rules through a Content Addressable Memory (CAM) or Ternary Content Addressable Memory (TCAM).

The switching, routing and gatewaying processing functions performed on the filtered and policed dataset may, for example, be forwarding of frames form ingress ports to egress ports of the networking device based on the routing/switching/gatewaying tables and the built-in information collected from the frames.

In an implementation form of the third aspect the networking device further includes a convolutional neural network, CNN, computation hardware engine according to the second aspect, where the 2D convolution hardware engine is integrated into the CNN computation hardware engine.

A fourth aspect of the present disclosure provides a method for a 2D convolution hardware engine for an inline and in-memory 2D convolution operation on a dataset, the method being performed by the 2D convolution hardware engine and including: receiving the dataset, shifting the dataset in a first direction of a 2D space, shifting the dataset in second direction of the 2D space, calculating a product of each pixel of an image kernel of the shifted dataset by multiplying the pixel with a filter weight of the kernel, and calculating a sum of the products of all pixels of the kernel of the shifted dataset.

The method of the fourth aspect and its implementation forms achieve the same advantages described above for the device of the first aspect and its respective implementation forms.

A fifth aspect of the present disclosure provides a method for a convolutional neural network, CNN, computation hardware engine for an inline and in-memory CNN computation operation on a dataset, the method being performed by the CNN computation hardware engine and including: receiving the dataset via an ingress port, performing an inline 2D convolution operation on the dataset by a 2D convolution hardware engine according to the first aspect, outputting a result of the inline 2D convolution operation performed on the dataset by an egress port, and looping back a result output by the 2D convolution hardware engine to an internal queue of the 2D convolution hardware engine to form a CNN path by means of a loopback path.

The method of the fifth aspect and its implementation forms achieve the same advantages described above for the device of the second aspect and its respective implementation forms.

The present disclosure relates to the development of new embedded networking and computing technology, targeting the effective integration within networking devices of processing of an inline 2D convolution operation on a received dataset. This primitive may be extended to a CNN computation hardware engine—e.g. for deep learning (DL) computation—configured to perform an inline CNN computation operation on the received dataset, and may be integrated as a co-processing unit in a networking device. These two primitives—the 2D convolution hardware engine and the CNN computation hardware engine—can be architected and deployed directly in hardware in the way of a peripheral or a co-processing unit that can easily be integrated into next generation SoC devices.

The benefits of integrating such a 2D convolution hardware engine and a CNN computation hardware engine into a networking device are described herein. For example, in the automotive electronics industry a next generation Zonal Gateway Controller, also referred to as an electronic control unit (ECU), is considered a key pillar for a next generation Automotive E/E In-Vehicle Network (IVN) architecture of a Software-Defined Vehicle. The next generation Zonal Gateway Controller is considered to be one of the most complex networking devices ever, for example, in terms of mixing heterogeneous functionality and networking technologies in a single device. The next generation Zonal Gateway Controller may incorporate high performance networking, functional safety, cyber security, and/or cross-domain zonal applications, such as body functions, infotainment, powertrain, connectivity and/or Advanced Driver Assistance Systems/Autonomous Driving (ADAS/AD).

Due to the divergent set of requirements demanded in a Zonal Gateway Controller, its system architecture results in an extremely challenging networking chipset conception and functional chipset conception, surpassing in complexity Information & Communication Technology (ICT) networking devices, like switches and routers that are based only on Ethernet protocol or automotive central gateways found today in vehicles following a domain-based E/E IVN architecture. For example, mixing Ethernet with other legacy network protocols like Controller Area Network (CAN) or FlexRay, but only integrating networking functions, mainly due to a further adoption of application functions on top of commodity networking functions of traditional gateways.

In an exemplary networking device with a plurality of ingress ports and a plurality of egress ports, for instance in an automotive zonal gateway controller in a vehicle, some of the plurality of ingress ports may be directly connected to cameras that send real-time images and/or real-time video to be processed by a computing unit. The computing unit may for example be an ECU of the vehicle and may be used for object recognition algorithms for AD. In this example the computing unit is required to get access to a payload information in networking frames, for example MIPI or Ethernet Layer 2, and is required to extract real-time image raw data from the networking frames to immediately process the real-time image raw data accordingly. Processing the real-time image raw data may for example include edge detection, normalization, binarization, and/or object recognition.

The present disclosure proposes to perform this computation operation through a dedicated hardware engine, which is integrated in the data path of the networking device, thus enabling inline 2D convolution operations and/or CNN computation operations. This provides improvements in performance, for example latency and throughput, in power consumption, in quality of service, for example image resolution, and achieves cost reductions.

However, the proposed technical solutions of the present disclosure may be implemented not only in the automotive industry, but also in many other industries and/or for various use cases. For example, the technical solutions may be implemented in cloud computing and data centers, industrial and smart manufacturing, home office local area networks (LANs), (industrial) internet of things (I)IoT) devices, and SmartNIC devices industry. In the same way, the proposed solutions may be adopted by many types of networking devices, from automotive gateway controllers to other traditional ICT networking devices for example switches or routers.

Further the present disclosure can provide a fully autonomous and/or automated solution for a CNN computation core, e.g., the CNN computation hardware engine, which may be implemented and performed exclusively in hardware, with no software intervention at all. Therein, software is understood as the execution by a CPU of a given algorithm described through source code and assembled in a specific sequence of machine instructions. In other words, the present disclosure proposes a design for a hardware-centric 2D convolution hardware engine and its integration in a CNN Computation core, e.g., a CNN computation hardware engine handled in a fully autonomous and/or automated way by a dedicated hardware engine.

The present disclosure is able to achieve the same level of flexibility that is achievable in software, but achieves improvements in performance at the same time, for example, ultra-low latency due to its implementation as a dedicated and customized hardware digital circuit instead of an implementation as a general-purpose hardware processing unit like a CPU or a GPU. The proposed technical solutions of this disclosure may be applied in the artificial intelligence (AI), machine learning (ML), and/or deep learning (DL) industry, as well as in networking device architectures.

For instance, the solutions of this disclosure may be used for image processing, intrusion detection systems based on ML as real-time security countermeasure against attacks and/or object classification and object recognition based on CNN processing in autonomous driving.

### BRIEF DESCRIPTION OF DRAWINGS

The above described aspects and implementation forms will be explained in the following description of specific embodiments in relation to the enclosed drawings, in which:

FIG. 1 shows a pipeline comprising first to fourth processing stages in a processing circuitry of a 2D convolution hardware engine according to an embodiment of the present disclosure;

FIG. 2 shows a pipeline architecture comprising first to fourth processing stages in a processing circuitry of a 2D convolution hardware engine according to an embodiment of the present disclosure;

FIG. 3 shows an inline 2D convolution operation on a received dataset performed by a 2D convolution hardware engine according to an embodiment of the present disclosure;

FIG. 4 shows an example of a 2D convolution hardware engine that is integrated into a convolutional neural network computation hardware engine according to an embodiment of the present disclosure;

FIG. 5 shows a simplified architecture of a networking device according to an embodiment of the present disclosure;

FIG. 6 shows an example architecture of a networking device, particularly an automotive gateway controller, in which a 2D convolution hardware engine according to an embodiment of the present disclosure is deployed;

FIG. 7 shows an example of a match processing stage and an action processing stage in the exemplary automotive gateway controller shown in FIG. 3 according to an embodiment of the present disclosure;

FIG. 8A shows an example of a 13×13 kernel of a filter according to an embodiment of the present disclosure;

FIG. 8B shows an example of a representation of an isotropic filtering according to an embodiment of the present disclosure;

FIG. 9 shows a method for an inline 2D convolution operation on a dataset according to an embodiment of the present disclosure; and

FIG. 10 shows a method for an inline CNN computation operation on a dataset according to an embodiment of the present disclosure.

### DETAILED DESCRIPTION

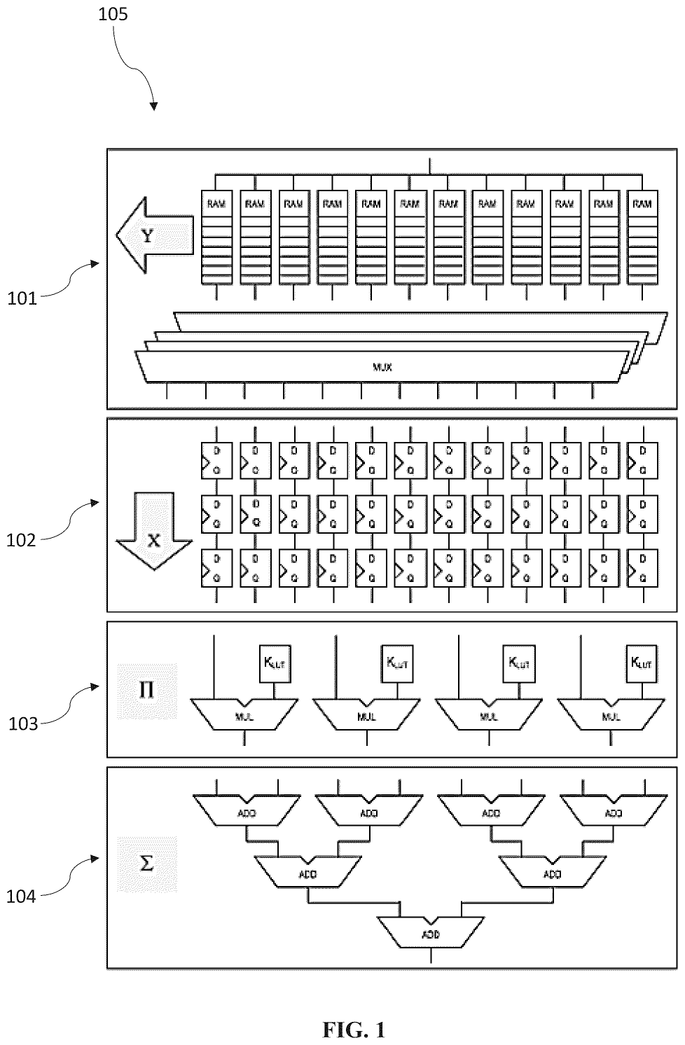

FIG. 1 shows a pipeline 105 comprising first to fourth processing stages in a processing circuitry of a 2D convolution hardware engine 100 according to an embodiment of the present disclosure. FIG. 1 shows the pipeline 105 split in four processing stages.

As shown in FIG. 1, a first processing stage 101 of the pipeline 105 is configured to shift a received dataset 201 in a first direction of a 2D space. In the first processing stage 101 the dataset 201, for example a 2D image 110, is shifted in the first direction, for example a Y direction, of the 2D space. For the example of the 2D image 110, in the first processing stage 101, full columns of 1-pixel width of the 2D image 110 may be shifted from right to left.

As shown in FIG. 1 a second processing stage 102 of the pipeline 105 is configured to shift the dataset 201 in a second direction of the 2D space. In the second processing stage 102 the dataset 201, for example the 2D image 110, is shifted in the second direction, for example an X direction of the 2D space. For the example of the 2D image 110, in the second processing stage 102, one or more kernels of K×K pixels may be shifted from a bottom to a top of the 2D image 110.

As shown in FIG. 1, a third processing stage 103 of the pipeline 105 is configured to calculate a product of each pixel of a kernel of the shifted dataset 201 by multiplying the pixel with a filter weight of the kernel. In the third processing stage 103, for example the 2D image 110, the product of each pixel of the kernel of the shifted 2D image 110 is calculated by multiplying the pixel, for example of the 2D image 110, with the filter weight of the kernel.

As shown in FIG. 1, a fourth processing stage 104 of the pipeline 105 is configured to calculate a sum of the products of all pixels of the kernel of the shifted dataset 201. In the fourth processing stage 104 the sum of the products of all pixels of the kernel of the shifted dataset 201, for example the 2D image 110, is calculated.

As can also be seen from FIG. 1, the multiple processing stages of the pipeline 105 may be performed consecutively or in parallel, for example, more than one pixel of the 2D image 110 at the same time. This may be achieved by scaling the four processing stages accordingly, which can also be described as four building blocks, in order to allocate more than one kernel concurrently. The multiple processing stages may also be partly performed consecutively and partly in parallel.

A 2D convolution operation performed by the processing circuitry may be a computation operation that is performed inline. For example, as soon as the dataset 201 is received across ingress ports 207 of the networking device 200. The received dataset 201 of the 2D convolution hardware engine 100 may be, for example, an ingress frame received across the ingress ports 207 of the networking device 200.

Advantageously, since the 2D convolution operation is processed inline, no large buffer to store a full dataset 201, for example a full 2D image 110, is necessary.

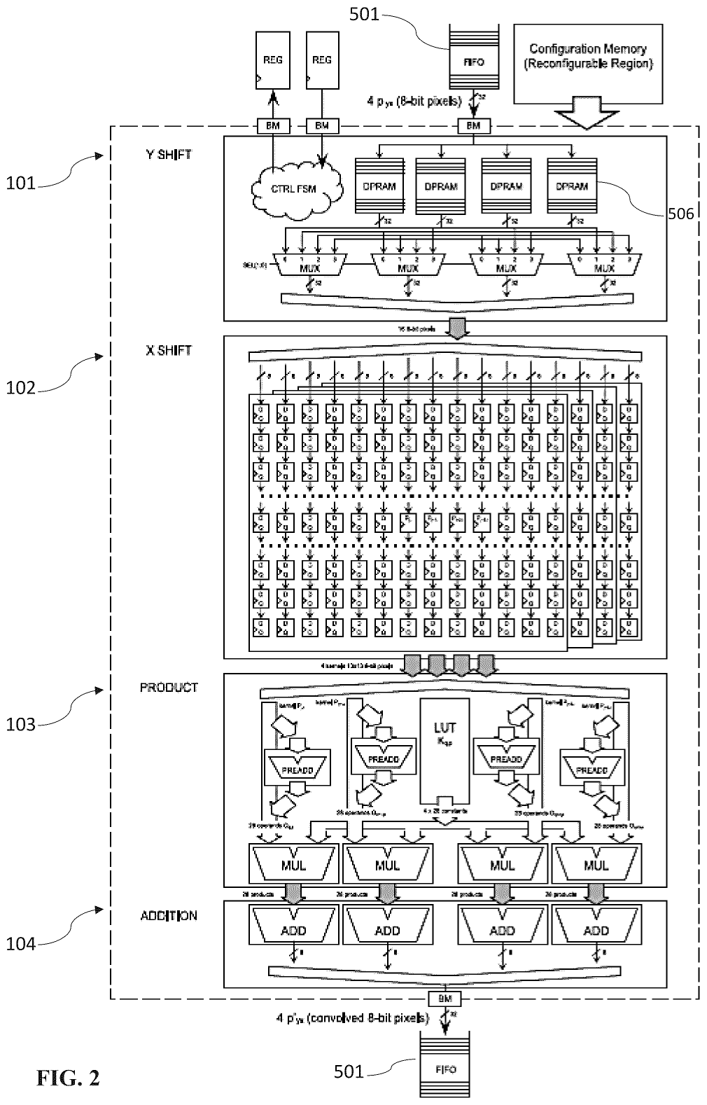

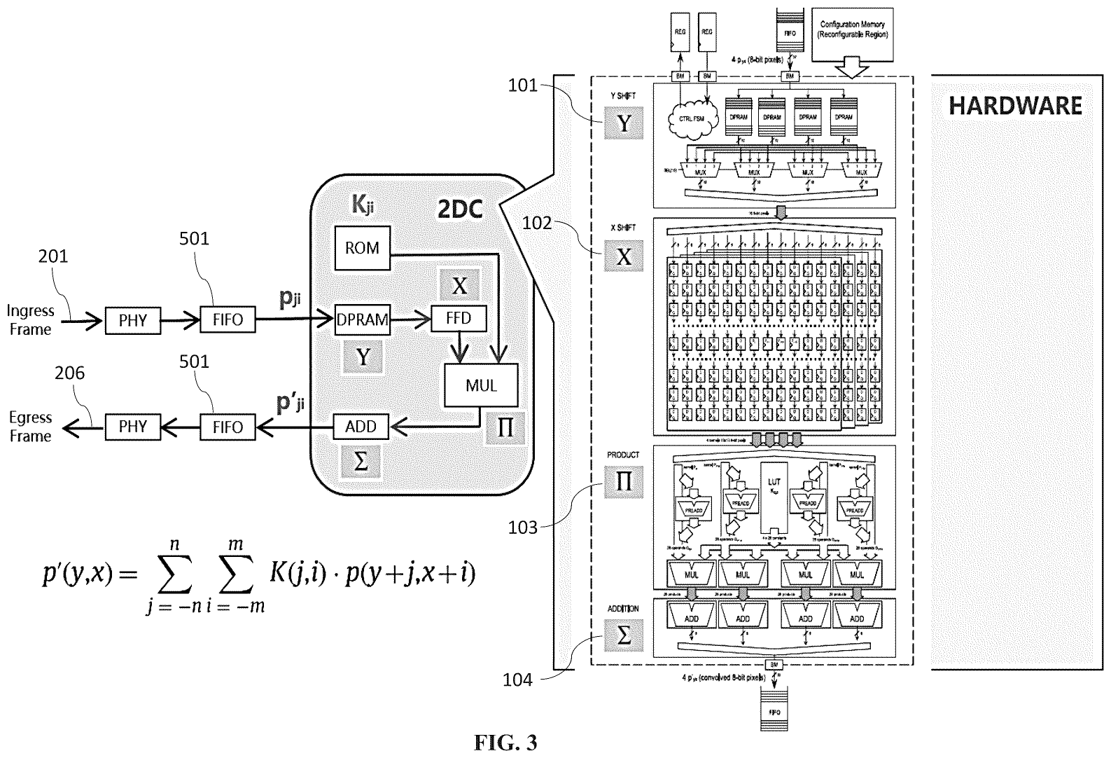

FIG. 2 shows a pipeline architecture comprising first to fourth processing stages in a processing circuitry of a 2D convolution hardware engine 100 according to an embodiment of the present disclosure. FIG. 3 shows an inline 2D convolution operation on a received dataset 201 performed by the 2D convolution hardware engine 100.

FIG. 2 and FIG. 3 illustrate one exemplary pipeline architecture in the 2D convolution hardware engine 100, which may be used to perform an inline and in-memory 2D convolution operation in hardware. As can be seen from FIG. 2 and FIG. 3, a processing path in the pipeline 105 is shown, which may be followed by every pixel of a 2D image. The exemplary pipeline architecture can take advantage of a parallelism based architecture and the pipeline architecture. The 2D convolution hardware engine 100 may, for example, be implemented and parallelized in a dedicated and made-to-measure hardware engine or Arithmetic-Logic Unit (ALU) with a Finite State Machine (FSM).

To explain the parallelism based architecture, an example of processing four pixels at the same time, i.e., of processing four pixels per clock, is now described. As illustrated in FIG. 2 and FIG. 3, to implement the parallelism based architecture four 13×13 kernels may be instantiated in the first processing stage 101 of the pipeline 105 and the second processing stage 102 of the pipeline 105, in order to process four consecutive pixels of a 2D image at the same time. As can be seen in FIG. 2 and FIG. 3, an interface to the four processing stages of the pipeline 105 of the 2D convolution hardware engine 100 may be one or more first in first out (FIFO) memories 501, i.e., queues, or one or more dual-port RAMs 506, also referred to as DPRAM 506.

The implementation of FIFO memories 501 and/or DPRAMs into the pipeline architecture advantageously eases an integration of the 2D convolution hardware engine 100 into a data path 209 of a networking device 200.

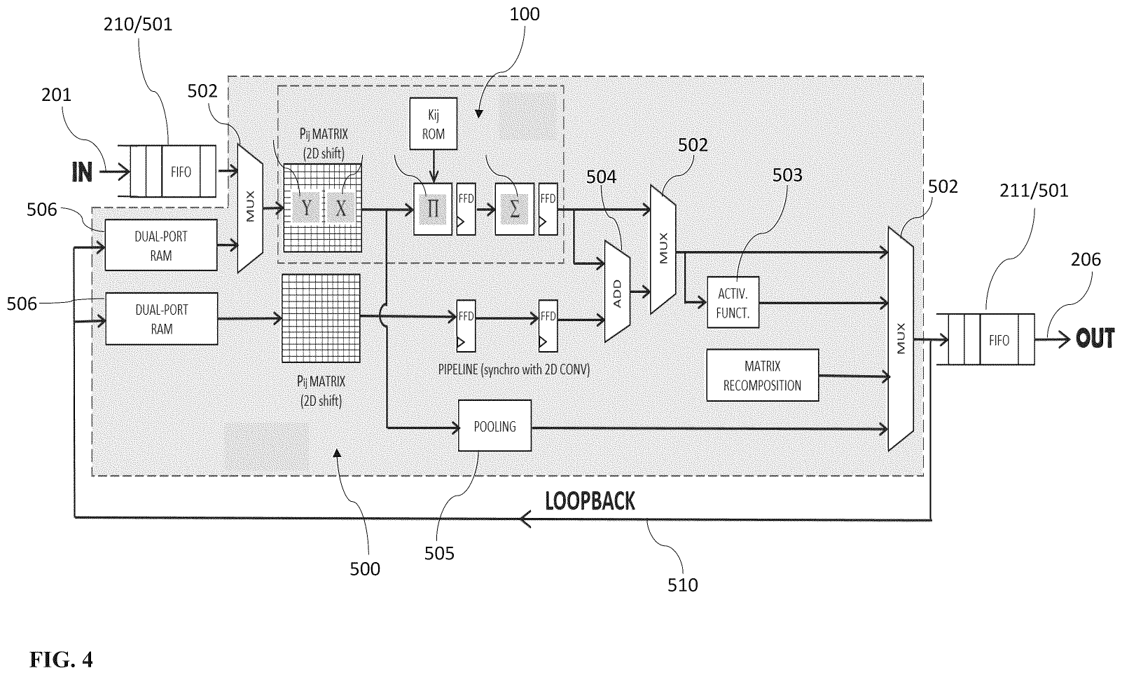

FIG. 4 shows an example of a 2D convolution hardware engine 100 that is integrated into a CNN computation hardware engine 500.

As can be seen in FIG. 4, the 2D convolution hardware engine 100 that is integrated into the CNN computation hardware engine 500 implements FIFO memories 501, i.e. queues, as interfaces, in order to instantiate the 2D convolution hardware engine 100 and/or the CNN computation hardware engine 500 in a data path 209 of the networking device 200 in a user-friendly manner.

As illustrated in FIG. 4, the 2D convolution hardware engine 100 may include an ingress port 207 for receiving a dataset 201. From the ingress port 207 the dataset 201 may be forwarded across internal queues 210 and 211 (e.g., FIFO memories 501) and then via a MUX, 502, for example, a first MUX, to the 2D convolution hardware engine 100. Within the 2D convolution hardware engine 100 the dataset 201 may be processed as described in FIG. 1 to 3, i.e., an inline 2D convolution operation may be performed. Following the 2D convolution hardware engine 100, the dataset 201 may be forwarded to a MUX 502, for example, a second MUX, or may be forwarded to an activation function processing stage, again followed by a MUX 502, for example, a third MUX. Passing the third MUX, the dataset 201 may for example be forwarded to a FIFO memory 501 outputting a processed dataset 206.

Alternatively, from the third MUX the dataset 201 may for example be looped back by means of a loopback path 510 to a DPRAM 506 of the CNN computation hardware engine 500. As illustrated in FIG. 4, any output of the CNN computation hardware engine 500 may be forwarded to the FIFO memory 501 outputting a processed dataset 206 to the egress ports 208 of the networking device 200, or may be looped back to previous stages of the 2D convolution operation or the CNN computation operation. This allows nested or iterative operations or computations. This may, for example, be the case for multilayered plain and residual CNNs for example AlexNet, GoogLeNet or ResNet.

In the following an example of an iterative implementation of a residual CNN like ResNet-50 will be described.

In the example of the residual CNN, it is necessary to save a result twice. A first result copy is saved to be used just in the next iteration in a first DPRAM 506. And a second result copy is saved to be used later in a second DPRAM 506.

Note that the second DPRAM 506 may only be necessary in the case of a residual CNN to recover a matrix computed not in a last iteration, but in some convolution cycles ago. Plain CNNs do not need the second DPRAM 506, since a value of a previous convolution done several convolution cycles before is not necessary to be recovered later. Only a value coming just from a last convolution cycle is required next to continue a computation of stages of the CNN. Therefore, in a case of plain convolution, the proposed architecture would be simplified by removing the second DPRAM 506 and its data path until an adder 504 of the CNN computation hardware engine 500.

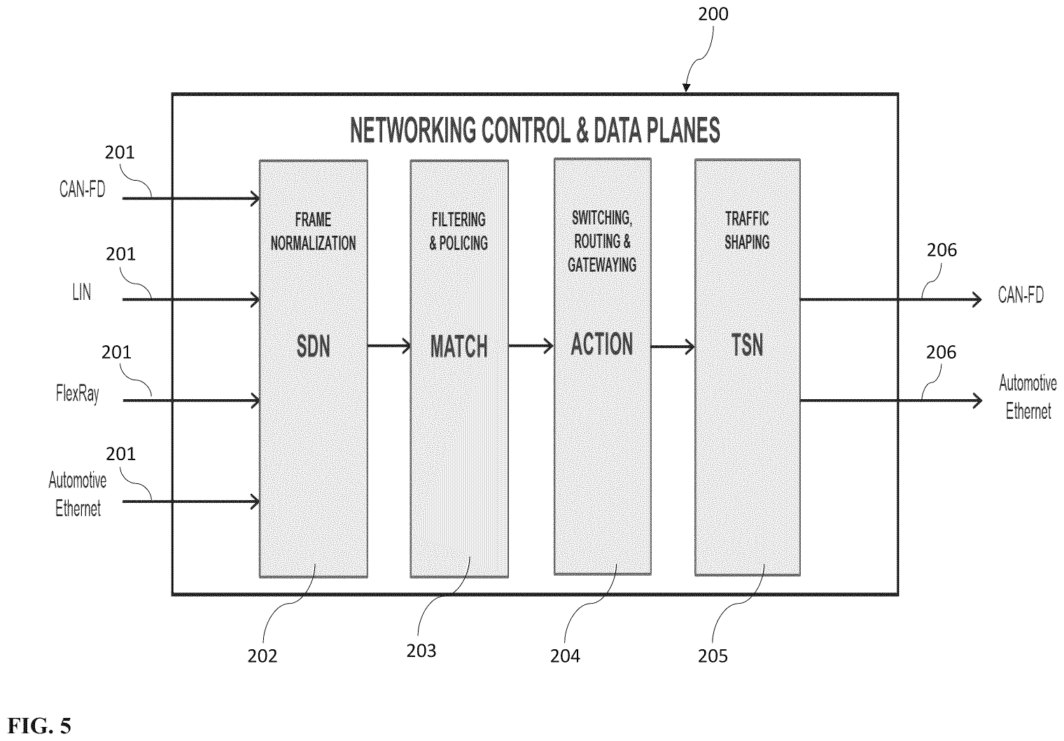

FIG. 5 shows a simplified architecture of a networking device 200 according to an embodiment of the present disclosure. The networking device 200 may for example apply to a Switch, a Router, a SmartNIC or a Gateway.

As illustrated in FIG. 5, the networking device 200 may be configured to receive a dataset 201 as an input, and provide a processed dataset 206 as an output. The networking device 200 may include four processing stages, in which the 2D convolution hardware engine 100 and the CNN computation hardware engine 500 may be easily integrated into the architecture of a data path of the networking device 200. Advantageously the integration of the 2D convolution hardware engine 100 and the CNN computation hardware engine 500 does not cause any interference or incompatibility with the architecture of the networking device 200.

As illustrated in FIG. 5, the networking device 200 may, for example, include a normalization processing stage, a match processing stage, an action processing stage and/or a traffic shaping processing stage.

In the normalization processing stage 202, the networking device 200 of FIG. 5 may, for example, be configured to perform normalization functions on the received dataset 201. In the match processing stage 203, the networking device 200 may, for example, be configured to perform filtering and policing functions on the normalized dataset 201. In the action processing stage 204, the networking device 200 may, for example, be configured to perform switching, routing and gatewaying processing functions on the filtered and policed dataset 201.

The action processing stage illustrated in FIG. 5 of the networking device 200 may, for example, include the 2D convolution hardware engine. The 2D convolution hardware engine 100 may be configured to perform inline 2D convolution operations on the filtered and policed dataset 201 in the action processing stage 204. For example, the 2D convolution hardware engine 100 may be integrated into the CNN computation hardware engine 500.

Advantageously, the 2D convolution hardware engine 100 and/or the CNN computation hardware engine 500 may be implemented into a commercial networking device or networking SoC device.

Advantageously, the 2D convolution hardware engine and/or the CNN computation hardware engine proposed may in general improve architecture, performance and Quality of Service (QoS) of networking devices focusing on 2D convolution operations. This advantage is also supported by the flexibility of prioritization of each individual frame.

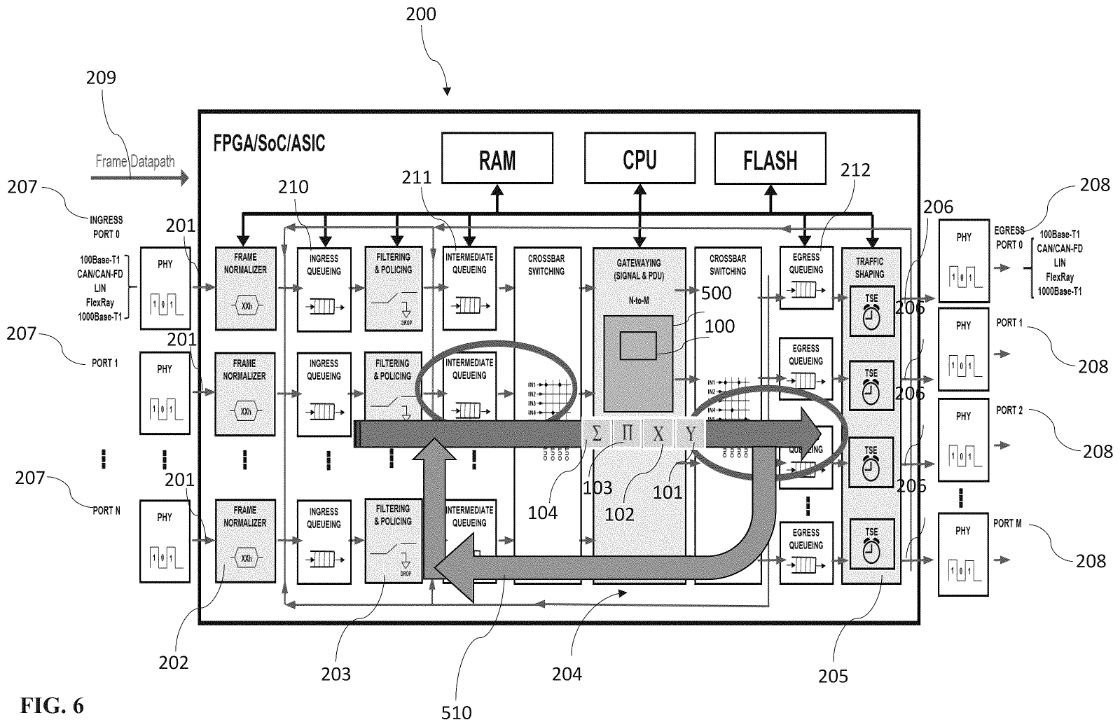

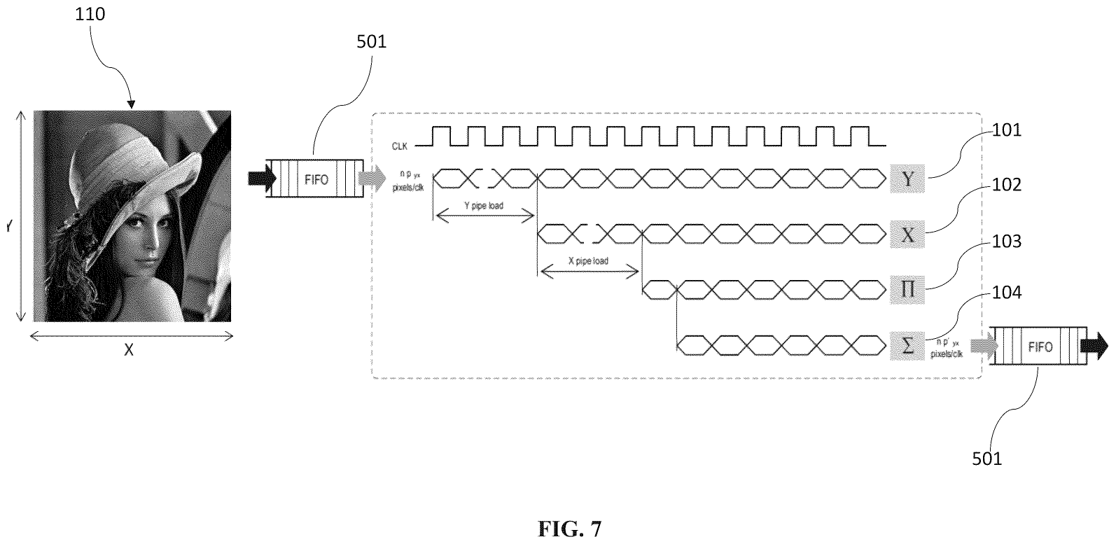

FIG. 6 shows an example architecture of a networking device 200, particularly an automotive gateway controller, in which a 2D convolution hardware engine 100 according to the present disclosure is deployed. FIG. 7 shows an example of a match processing stage 203 and an action processing stage 204 in the exemplary automotive gateway controller shown in FIG. 6 according to an embodiment of the present disclosure.

FIG. 6 and FIG. 7 show an exemplary mapping of the 2D convolution hardware engine 100 inside the networking device 200. The 2D convolution hardware engine 100 may be allocated inside the action processing stage 204, i.e. gatewaying, of the networking device 100.

As illustrated in FIG. 6 and FIG. 7, in the action processing stage 204 of the networking device 200, named Gatewaying in FIG. 6, the 2D convolution hardware engine 100 may execute in pipeline the four processing stages of the 2D convolution hardware engine 100 described in FIG. 1.

Therefore, the inline and in-memory 2D convolution operation may be distributed across the four processing stages of the 2D convolution hardware engine 100 described in FIG. 1, with a negligible overhead in terms of hardware resources and virtually no degradation in latency. The inline and in-memory 2D convolution operation, inside the Gatewaying block, named Gatewaying in FIG. 6, gets allocated amid a stage of input queues 211 (intermediate queueing) and a stage of egress queues 212 (egress queueing). Advantageously, this facilitates the integration of the 2D convolution hardware engine 100 in a fast inline data path of the networking device 100.

As illustrated in FIG. 6, a CNN computation hardware engine 500 may be integrated in the action processing stage 204 of the networking device 200, named Gatewaying. The CNN computation hardware engine 500 may be integrated in a similar way as the 2D convolution hardware engine 100 described above. In this example the 2D convolution hardware engine 100 may be integrated into the architecture of the CNN computation hardware engine 500.

As illustrated in FIG. 7, the 2D convolution operation is performed, thus computed, uninterruptedly at a rate of one or more pixels per clock. This depends on a number of parallel kernels instantiated in the first processing stage 101 and the second processing stage 102 of the pipeline.

In the example illustrated in FIG. 6, frames in a frame data path 209 may flow through ingress ports 207 across a normalization processing stage 202, a match processing stage 203, an action processing stage 204 and a traffic shaping processing stage 205 and may be stored temporarily in intermediate queues 211, which may also be referred to as parallel queues, of the networking device 200. The frames in the frame data path 209 may be processed on the fly by the 2D convolution hardware engine 100 and/or the CNN computation hardware engine 500. A result of the processing may be forwarded to Egress Queues 212. The example described above of directly forward processing of the frames in the frame data path 209 may be referred to as a fast forward path.

Apart from the fast forward path of frames, there may also be further applications for the 2D convolution hardware engine 100 and/or the CNN computation hardware engine 500. For instance, in image processing of real-time images captured by a camera in a vehicle that processes the real-time images by means of 2D convolution operations, edge detection or binarization. The result may then be sent to an end-node, and in some cases it may be necessary to use the resulting preprocessed real-time images in further iterations of 2D convolution operations.

A typical use case for the above described example is a computation of a CNN with a plurality of layers. For this application, the networking device 200 is provided with a loopback path 510, as illustrated in FIG. 6, which allows to loop the preprocessed real-time images of a 2D convolution operation back to the intermediate queues 211 in order to use the preprocessed real-time images as an input for further iterations of 2D convolution operations.

Advantageously, the loopback path 510 enables an effective hardware implementation of algorithms that either are recursive or require to iterate on the same type of computation a plurality of times before ending, like this is the case in CNN computation.

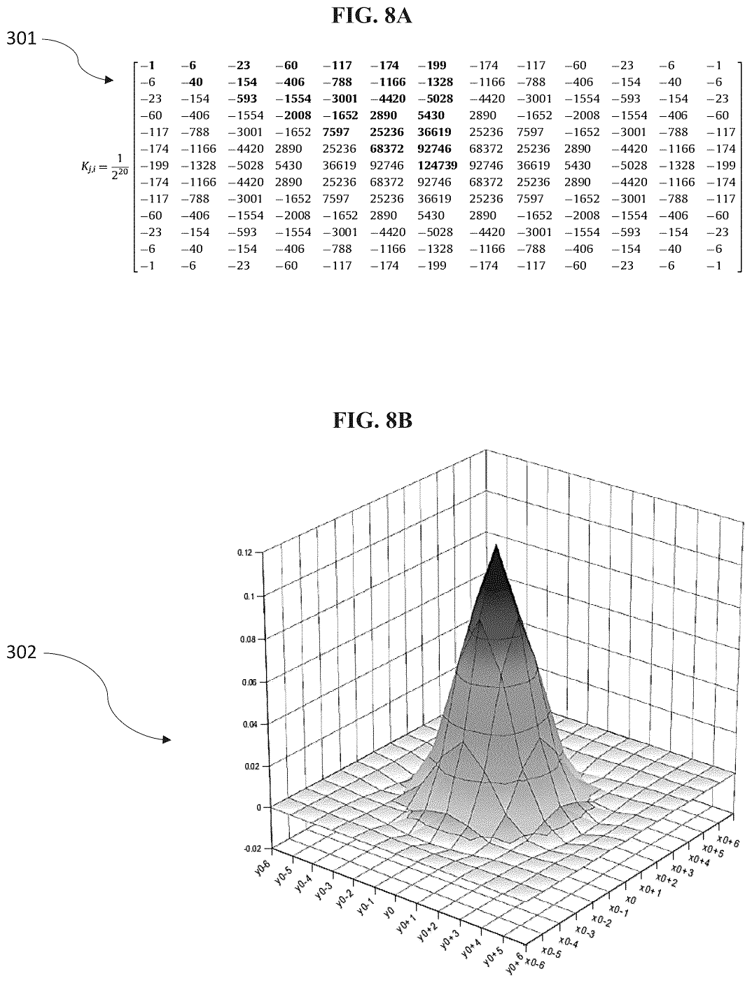

FIG. 8A shows an example of a 13×13 kernel of a filter according to an embodiment of the present disclosure and FIG. 8B shows an example of a representation of an isotropic filtering according to an embodiment of the present disclosure.

FIG. 8A shows an example of a inline CNN computation operation of a filter of a 13×13 kernel with specific parameters or weights Kj, i.

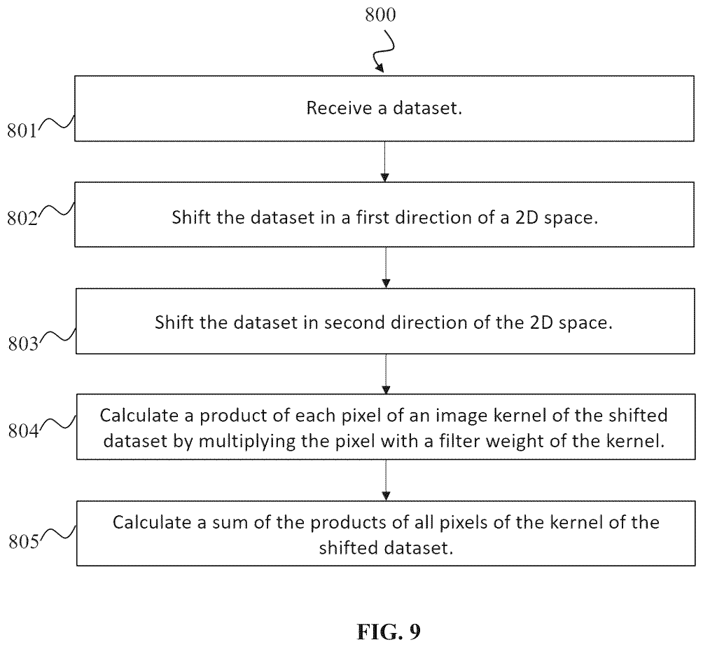

FIG. 9 shows a method for an inline 2D convolution operation on a dataset 201 according to the present disclosure. The method may be performed by the 2D convolution hardware engine 100. The method 800 includes step 801 of receiving the dataset 201. The method 800 further includes step 802 of shifting the dataset 201 in a first direction of a 2D space. Further the method 800 includes step 803 of shifting the dataset 201 in second direction of the 2D space. Furthermore the method 800 includes step 804 of calculating a product of each pixel of an image kernel of the shifted dataset 201 by multiplying the pixel with a filter weight of the kernel. Finally the method 800 includes step 805 of calculating a sum of the products of all pixels of the kernel of the shifted dataset 201.

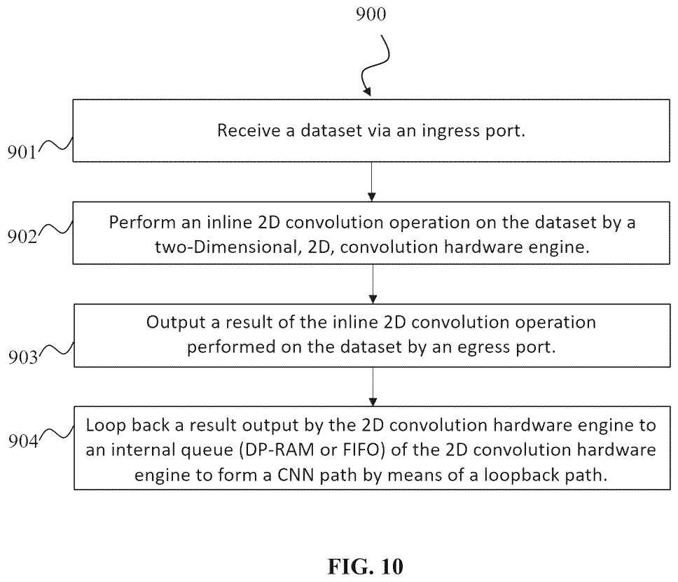

FIG. 10 shows a method 900 for an inline CNN computation operation on a dataset 201 according to the present disclosure.

The method 900 may be performed by the CNN computation hardware engine 500. The method 900 includes step 901 of receiving the dataset 201 via an ingress port 207 that is transferred to an internal queue 211 (e.g., a FIFO memory 501). Further the method 900 includes step 802 of performing an inline 2D convolution operation on the dataset 201 by a 2D convolution hardware engine 100. The method 900 further includes step 903 of outputting a result of the inline 2D convolution operation performed on the dataset 201 by an egress port 208. Finally, the method 900 includes step 904 of looping back a result output by the 2D convolution hardware engine 100 to an internal queue (e.g., a DP-RAM or FIFO) of the 2D convolution hardware engine to form a CNN path by means of a loopback path.

The present disclosure has been described in conjunction with various embodiments as examples as well as implementations. However, other variations can be understood and effected by those persons skilled in the art and practicing the claimed matter, from the studies of the drawings, the present disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A Two-Dimensional (2D) convolution hardware engine for a networking device, the 2D convolution hardware engine comprising processing circuitry,
wherein the processing circuitry comprises multiple processing stages connected to form a pipeline and configured to perform an inline and in-memory 2D convolution operation on a received dataset, wherein:
a first processing stage of the pipeline is configured to shift the dataset in a first direction of a 2D space,
a second processing stage of the pipeline is configured to shift the dataset in a second direction of the 2D space,
a third processing stage of the pipeline is configured to calculate a product of each pixel of a kernel of the shifted dataset by multiplying the pixel with a filter weight of the kernel, and
a fourth processing stage of the pipeline is configured to calculate a sum of the products of all pixels of the kernel of the shifted dataset.

2. The 2D convolution hardware engine according to claim 1, wherein
the dataset is a 2D image.

3. The 2D convolution hardware engine according to claim 1, wherein
the inline 2D convolution is executed in parallel and/or simultaneously for two or more pixels of the dataset.

4. The 2D convolution hardware engine according to claim 1, further comprising a first set of configurable registers configured to be programmed with a first set of values, and to be accessible by the processing circuitry at an initialization phase and/or during the inline 2D convolution operation of the 2D convolution hardware engine, wherein the first set of values defines one or more physical parameters related to the inline 2D convolution operation performed on the dataset.

5. The 2D convolution hardware engine according to claim 4, wherein the first set of configurable registers is configured to be memory mapped.

6. The 2D convolution hardware engine according to claim 1, further comprising a second set of configurable registers configured to be programmed with a second set of values, and to be accessible by the processing circuitry at the initialization phase and/or during the inline 2D convolution operation of the 2D convolution hardware engine, wherein the second set of values defines one or more functional parameters related to the inline 2D convolution operation performed on the dataset.

7. The 2D convolution hardware engine according to claim 6, wherein the second set of configurable registers is configured to be memory mapped.

8. The 2D convolution hardware engine according to claim 1, further comprising:
an ingress port for receiving the dataset; and/or
an egress port for outputting a result of the 2D convolution operation performed on the dataset.

9. A convolutional neural network (CNN) computation hardware engine configured to perform an inline and in-memory CNN computation operation on a received dataset comprising:
an ingress port for receiving the dataset;
a Two-Dimensional (2D) convolution hardware engine according to claim 1 configured to perform an inline 2D convolution operation on the dataset;
an egress port for outputting a result of the inline 2D convolution operation performed on the dataset; and
a loopback path configured to loop back the result output by the 2D convolution hardware engine as an input to the 2D convolution hardware engine to form a CNN path.

10. The CNN computation hardware engine according to claim 9, further comprising one or more multiplexers (MUX) configured to select between two or more input datasets to output one selected output dataset.

11. The CNN computation hardware engine according to claim 9, further comprising one or more dual-port random access memories (RAMs) configured to simultaneously permit one or more reads and one or more writes of one or more datasets.

12. The CNN computation hardware engine according to claim 11, wherein the one or more dual-port RAMs are either one or more first in first out (FIFO) or simple and/or true dual-port RAM memories configured to queue one or more input datasets and/or one or more output datasets of the 2D convolution hardware engine.

13. The CNN computation hardware engine according to claim 9, further comprising a pooling processing stage configured to reduce a dimension of the dataset.

14. The CNN computation hardware engine according to claim 9, further comprising an activation function processing stage configured to calculate a weighted sum of pixels of a kernel input to an activation function processing stage, and add a bias to a weighted sum.

15. The CNN computation hardware engine according to claim 9, further comprising:
two or more dual-port RAMs comprising at least a first dual-port RAM and a second dual-port RAM, wherein the loopback path is further configured to loop back the output of the 2D convolution hardware engine and/or a pooling processing stage and/or an activation function processing stage to the first dual-port RAM and/or to the second dual-port RAM to form a residual CNN path;
a shift processing stage comprising:
a first shift processing stage configured to shift the dataset in a first direction of a 2D space, and
a second shift processing stage configured to shift the dataset in a second direction of the 2D space; and
an adding processing stage configured to add the result output by the 2D convolution hardware engine to an output of the second dual-port RAM.

16. The CNN computation hardware engine according to claim 9, further comprising a third set of configurable registers configured to be programmed with a third set of values, and to be accessible by the processing circuitry at an initialization phase and/or during the inline CNN computation operation of the CNN computation hardware engine, wherein the third set of values defines one or more physical parameters related to the inline CNN computation operation performed on the dataset.

17. The CNN computation hardware engine according to claim 16, wherein the third set of configurable registers is configured to be memory mapped.

18. The CNN computation hardware engine according to claim 9, further comprising a fourth set of configurable registers configured to be programmed with a fourth set of values, and to be accessible by the processing circuitry at the initialization phase and/or during the inline CNN computation operation of the CNN computation hardware engine, wherein the fourth set of values defines one or more functional parameters related to the inline CNN computation operation performed on the dataset.

19. The CNN computation hardware engine according to claim 18, wherein the fourth set of configurable registers is configured to be memory mapped.

20. A networking device configured to receive a dataset as an input and provide a processed dataset as an output, the networking device comprising:
a normalization processing stage, wherein the networking device is configured to perform normalization functions on the received dataset in the normalization processing stage to provide a normalized dataset;
a match processing stage, wherein the networking device is configured to perform filtering and policing functions on the normalized dataset in the match processing stage to provide a filtered and policed dataset; and
an action processing stage configured to perform switching, routing and gatewaying processing functions on the filtered and policed dataset in the action processing stage,
wherein the action processing stage comprises a Two-Dimensional (2D) convolution hardware engine according to claim 1, and wherein the 2D convolution hardware engine is configured to perform inline 2D convolution operations on the filtered and policed dataset in the action processing stage.

21. The networking device according to claim 20, further comprising a convolutional neural network (CNN) computation hardware engine, wherein the 2D convolution hardware engine is integrated into the CNN computation hardware engine.

22. A method for a Two-Dimensional (2D) convolution hardware engine for an inline and in-memory 2D convolution operation on a dataset, the method being performed by the 2D convolution hardware engine and comprising:
receiving the dataset;
shifting the dataset in a first direction of a 2D space;
shifting the dataset in a second direction of the 2D space;
calculating a product of each pixel of an image kernel of the shifted dataset by multiplying the pixel with a filter weight of the image kernel; and
calculating a sum of the products of all pixels of the image kernel of the shifted dataset.

23. A method for a convolutional neural network (CNN) computation hardware engine for an inline and in-memory CNN computation operation on a dataset, the method being performed by the CNN computation hardware engine and comprising:
receiving the dataset via an ingress port;
performing an inline Two-Dimensional (2D) convolution operation on the dataset by a 2D convolution hardware engine according to claim 1;
outputting a result of the inline 2D convolution operation performed on the dataset by an egress port; and
looping back the result output by the 2D convolution hardware engine to an internal queue of the 2D convolution hardware engine to form a CNN path by means of a loopback path.
